(19) United States
(12) Patent Application Publication
(10) Pub. No.: US 2016/0049268 A1
(43) Pub. Date: Feb. 18, 2016

(54) Switchgear

(71) Applicant: HITACHI, LTD., Tokyo (JP)

(72) Inventors: Toshiaki ROKUNOHE, Tokyo (JP); Tatsuro KATO, Tokyo (JP); Jun NUKAGA, Tokyo (JP); Tomohiro MORIYAMA, Tokyo (JP); Kenji TSUCHIYA, Tokyo (JP)

(73) Assignee: Hitachi, Ltd., Chiyoda-ku, Tokyo (JP)

(21) Appl. No.: 14/783,000

(22) PCT Filed: Mar. 7, 2014
(86) PCT No.: PCT/JP2014/055904

§ 371 Date: Oct. 7, 2015

(30) Foreign Application Priority Data
Apr. 22, 2013 (JP) 2013-089063

(51) Int. Cl. H01H 33/18

(52) U.S. Cl. CPC H01H 33/182

(57) ABSTRACT

Magnetic force of a permanent magnet can be converted into arc driving force efficiently, and the permanent magnet can be insulated from arc heat so as to suppress magnetic deterioration, whereby breaking performance can be secured over a long period of time. In order to solve the above-described problems, the switchgear of the present invention includes: a fixed side contactor that is provided to a fixed side conductor; a moving contact that can be driven reciprocally with respect to the fixed side contactor, the moving contact being supported by a movable side conductor via a movable side contactor, the moving contact performing opening and closing operation by contacting to and separating from the fixed side contactor; and a permanent magnet generating a magnetic field on an arc to extinguish the arc through the opening operation, the arc being generated between the fixed side contactor and the moving contact, and the permanent magnet is provided on a tip portion of the fixed side conductor to be positioned closer to the movable side contactor side than the fixed side contactor, and the permanent magnet is covered with an insulating member.

### TECHNICAL FIELD

The present invention relates to a switchgear suitable for a disconnector, an earthing switch, a complex switch combining a disconnector and an earthing switch and the like, which adopt, for example, dry air, N₂, CO₂, SF₆ or mixed gas such as CO₂/N₂ and SF₆/N₂ as an insulating medium.

### BACKGROUND ART

Conventionally, a gas insulated switchgear (hereinafter, referred to as a GIS) adopting SF₆ gas or the like as an insulating medium has been broadly used. An example of a disconnector for this GIS is disclosed in PTL 1. This PTL 1 describes that a ring-shaped permanent magnet is arranged on a periphery of a fixed contactor, and electromagnetic force is applied to an arc generated between the fixed contactor and a tip of a moving contact so as to improve current breaking performance, and that the permanent magnet is arranged in a metal shield for considering insulation and preventing conventional upsizing.

Also, downsizing is disclosed in PTL 2. This PTL 2 describes that, in order to relieve an electric field between and near electrodes, insulation coatings made of electrically insulating organic polymer that contain sintered powder of zinc oxide are arranged respectively on each tip of a metal electric field relieving shield and a surface of a high electric field portion near the tip, so that, even if a gap is generated between a shield electrode and the insulation coating, tracking occurred by escalation of the discharge of this gap is prevented, and penetration breakdown of the insulation coating is prevented, thereby maintaining the reliability while realizing the downsizing.

Further, a structure that enables easy adjustment of magnetic field strength is disclosed in PTL 3. This PTL 3 describes that a toric fixed side arc shield having an opening hole whose diameter is larger than an outer diameter of a moving contact is provided on a tip of a fixed side shield, and a groove is provided inside this fixed side arc shield, in which a permanent magnet is arranged.

Whereas, PTL 4 describes that a cylindrical fixed arc contact point is arranged inside a fixed main contact point, and a permanent magnet is provided inside the fixed arc contact point so that magnetic boles may be arrayed along a driving direction, whereby a magnetic field acted on an arc is made stronger than that in the case of arranging the fixed arc contact point outside the fixed main contact point so as to improve the current breaking performance.

Moreover, an example of the earthing switch is disclosed in PTL 5. This PTL 5 describes that, by arranging a permanent magnet on a side of a moving contact, magnetic deterioration of the permanent magnet (magnetic force is weakened) by arc heat is suppressed, whereby high breaking performance can be maintained stably over a long period of time.

### CITATION LIST

### Patent Literatures

PTL 1: Japanese Patent Application Laid-Open (JP-A) 2010-251056 A
PTL 2: JP-A 2009-124848
PTL 3: JP-A 2007-323992
PTL 4: JP-A 2002-334636
PTL 5: JP-A 2009-54364

### SUMMARY OF INVENTION

### Technical Problem

However, in the disconnectors or the earthing switchgears for GISs described in above-listed PTLs 1 to 5, the permanent magnet is necessary to be arranged closer to the arc for improving the breaking performance, but, in order to realize this arrangement, there are problems in a method for fixing the permanent magnet and the damage or the magnetic deterioration of the permanent magnet by the arc heat.

For example, in the case of ignoring the arc heat, it is ideal to arrange the permanent magnet slightly closer to a movable side conductor side than a fixed contactor, but in this case, there are problems in the method for fixing the permanent magnet, and in that insulation performance at the time of a moving contact performing opening operation has to be secured without upsizing the disconnector and the permanent magnet also has to be protected from the arc heat.

The present invention has been made in the light of the above-described problems, and aims to provide switchgear which can convert magnetic force of a permanent magnet into arc driving force efficiently, and can insulate the permanent magnet from arc heat so as to suppress the magnetic deterioration, thereby enabling to secure breaking performance over a long period of time.

### Solution to Problem

To achieve the above object, a switchgear of the present invention includes: a fixed side contactor that is provided to a fixed side conductor; a moving contact that can be driven reciprocally with respect to the fixed side contactor, the moving contact being supported by a movable side conductor via a movable side contactor, the moving contact performing opening and closing operation by contacting to and separating from the fixed side contactor; and a permanent magnet generating a magnetic field on an arc to extinguish the arc through the opening operation, the arc being generated between the fixed side contactor and the moving contact, and the permanent magnet is provided on a tip portion of the fixed side conductor to be positioned closer to the movable side contactor side than the fixed side contactor, and the permanent magnet is covered with an insulating member.

### Advantageous Effects of Invention

According to the invention, magnetic force of a permanent magnet can be converted into arc driving force efficiently, and the permanent magnet can be insulated from arc heat so as to suppress the magnetic deterioration, thereby enabling to secure the breaking performance over a long period of time.

### BRIEF DESCRIPTION OF DRAWINGS

FIG. 1 is a cross-sectional view between movable side conductor and a fixed side conductor, and in a vicinity thereof, showing a closing state of a switchgear in Example 1 of the present invention.

FIG. 2 a cross-sectional view between the movable side conductor and the fixed side conductor, and in the vicinity thereof, showing a state that a moving contact performs opening operation of the switchgear in Example 1 of the present invention (during arc ignition).

FIG. 3 is a cross-sectional view between the movable side conductor and the fixed side conductor, and in the vicinity thereof, showing an opening state of the switchgear in Example 1 of the present invention.

FIG. 4 is a cross-sectional view between a movable side conductor and a fixed side conductor, and in a vicinity thereof, showing a closing state of a switchgear in Example 2 of the present invention.

FIG. 5 is a cross-sectional view between the movable side conductor and the fixed side conductor, and in the vicinity thereof, showing an opening state of the switchgear in Example 2 of the present invention.

FIG. 6 is a cross-sectional view between a movable side conductor and a fixed side conductor, and in a vicinity thereof, showing a closing state of a switchgear in Example 3 of the present invention.

FIG. 7 is a cross-sectional view between a movable side conductor and a fixed side conductor, and in a vicinity thereof, showing a closing state of a switchgear in Example 4 of the present invention.

FIG. 8 a cross-sectional view of between a movable side conductor and a fixed side conductor, and in a vicinity thereof, showing a state that a moving contact performs opening operation of a switchgear in Example 5 of the present invention (during arc ignition).

### DESCRIPTION OF EMBODIMENTS

According to the present invention, in a switchgear such as a disconnector, an earthing switch and a complex switch combining a disconnector and an earthing switch, which adopt, for example, dry air, N₂, CO₂, SF₆ or mixed gas such as CO₂/N₂ and SF₆/N₂ as an insulating medium, a moving contact performs opening and closing operation by contacting to and separating from a fixed side contactor, and a permanent magnet generates a magnetic field on an arc to extinguish the arc through the opening operation, the arc being generated between the fixed side contactor and the moving contact, and the permanent magnet is provided on a tip portion of a fixed side conductor to be positioned closer to the movable side contactor side than the fixed side contactor, and the permanent magnet is covered with an insulating member.

Thereby, the insulating member that aims for the electric field relieving effect and the field emission electron suppression is provided on the tip of the fixed side conductor, and the insulating member has the permanent magnet therein, whereby both of the current breaking performance and the downsizing can be achieved at higher levels, and the performance thereof can be maintained over a long period of time.

Hereinafter, the switchgear of the present invention will be described by way of examples that are illustrated by the figures. Incidentally, in the examples below, a tank, a link between an operation unit and a driving system and the like are omitted, because they are within a range of the application of the conventional art.

### EXAMPLE 1

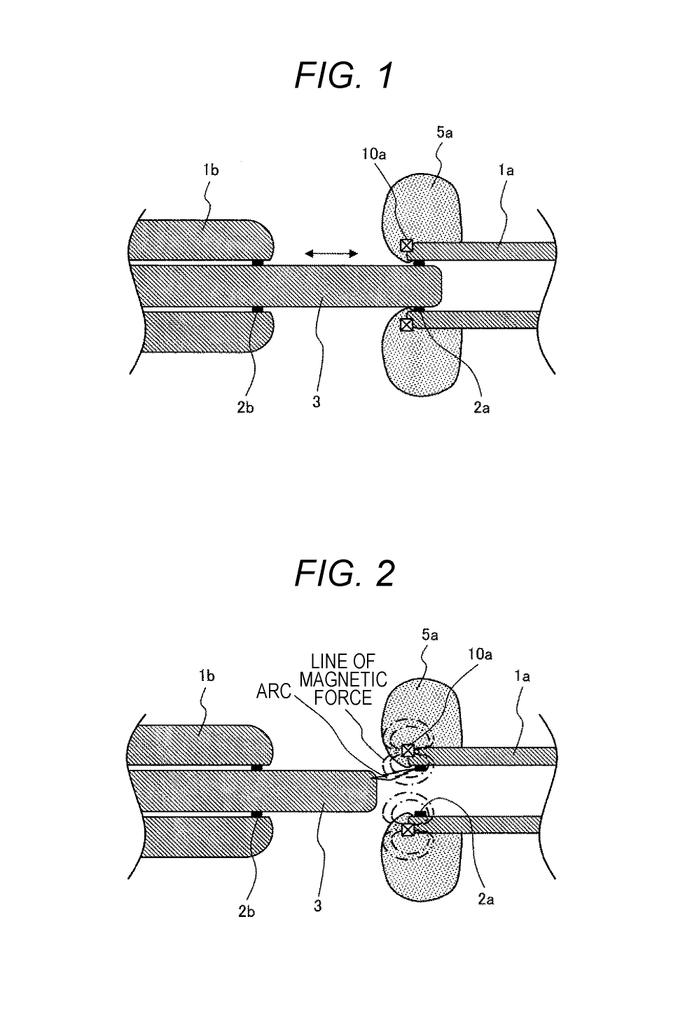

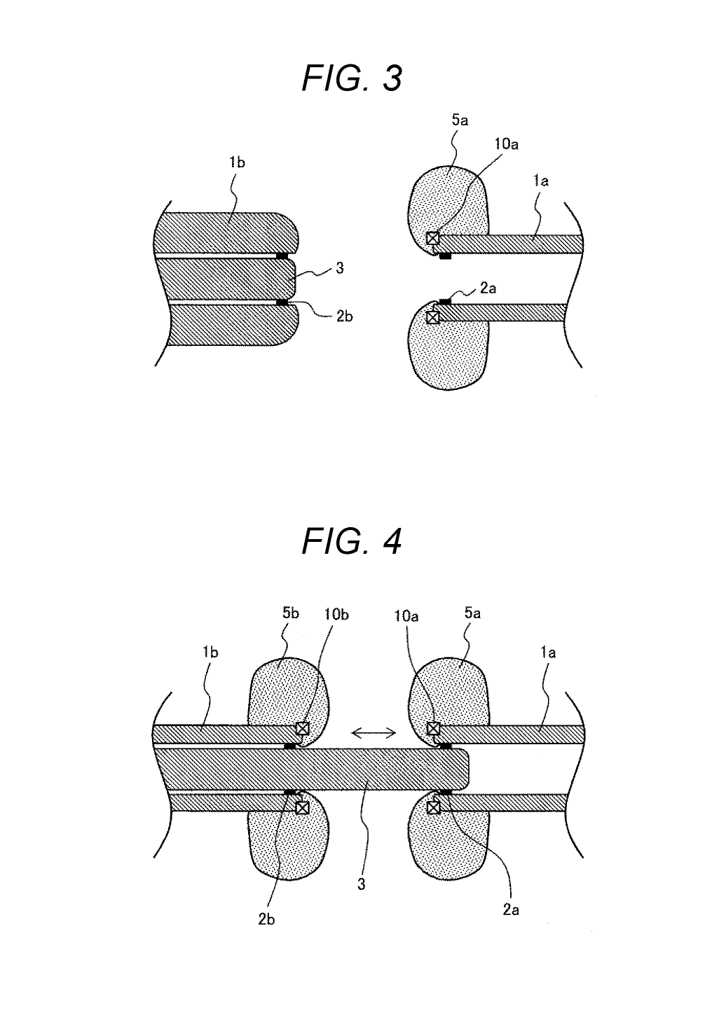

FIGS. 1 to 3 illustrate a gas insulation disconnector that is a switchgear in Example 1 of the present invention. FIG. 1 illustrates a closing state of a switch gear; FIG. 2 illustrates a state that a moving contact performs opening operation of the switchgear (during arc ignition); and FIG. 3 illustrates an opening state of the switchgear.

As shown in the figures, the gas insulation disconnector of the present example includes: a fixed side conductor 1a that is formed in a hollow cylindrical shape; a fixed side contactor 2a that is provided inside this fixed side conductor 1a; a moving contact 3 that can be driven reciprocally with respect to the fixed side contactor 2a, and is supported to a movable side conductor 1b via a movable side contactor 2b; a ring-shaped permanent magnet 10a that is provided on a periphery side of a tip portion of the fixed side conductor 1a to be positioned closer to the movable side contactor 2b than the fixed side contactor 2a (a groove may be provided in a tip center portion of the fixed side conductor 1a, and the permanent magnet 10a may be arranged in this groove); and a fixed side insulating member 5a that covers a surrounding of the permanent magnet 10a and is made of, for example, epoxy resin or the like, and they are stored with an insulating medium of dry air, N₂, CO₂, SF₆ or mixed gas such as CO₂/N₂ and SF₆/N₂ in a tank which is not illustrated.

Incidentally, the permanent magnet 10a may be molded by the fixed side insulating member 5a and then fixed to the fixed side conductor 1a, and may be fixed to the tip portion of the fixed side conductor 1a on the periphery side and then molded by the fixed side insulating member 5a. This is the same in the respective examples that will be described below.

In such a structure of the present example, a current flows from the fixed side conductor 1a via the fixed side contactor 2a, the moving contact 3 and the movable side contactor 2b to the movable side conductor 1b. Further, the moving contact 3 has a structure of performing opening and closing operations of the switchgear with the fixed side contactor 2a by moving in left and right directions shown by an arrow in FIG. 1. Further, near the tip of the fixed side conductor 1a, the fixed side insulating member 5a that is extended from the fixed side conductor 1a in the movable side conductor direction (the left and right direction shown by the arrow in FIG. 1) and an tank direction (a vertical direction in FIG. 1) is arranged and this fixed side insulating member 5a is provided with a curvature (a circle) formed on their facing side, thereby relieving an electric field at the tip the fixed side conductor 1a. Moreover, the fixed side insulating member 5a on the side of the moving contact 3 and on the movable side conductor side is necessary to have a certain level of a thickness for maintaining the thermal insulation.

FIG. 2 illustrates a middle stage from the closing state of FIG. 1 to the opening state (during the arc ignition) of the switchgear, in which an arc is generated between the fixed side contactor 2a and the tip of the moving contact 3. Due to the magnetic field generated by the permanent magnet 10a that is provided at the position of the present example, electromagnetic force is applied to this arc so as to drive to rotate the arc, whereby the current breaking performance can be enhanced. This current breaking mechanism is the same as those of PTLs 1, 3, 4 and 5.

In order to enhance the above-described current breaking performance more, a magnetic field that acts on the arc is necessary to be strengthened. In the structures described in PTLs 1 and 5, magnetic deterioration of the fixed side permanent magnet due to the arc heat can he suppressed, but since a distance between the arc and the permanent magnet is long, the application to a disconnector is difficult; the permanent magnet is upsized; and a magnetic body is required to be added, which prevents the downsizing.

Also in PTLs 3 and 4, the arc heat is attached to metal with high thermal conductivity or is exposed to plasmas whose temperatures are significantly high at the time of arc generation, whereby the magnetic deterioration is caused, so that it is difficult to secure the performance over a long period of time.

However, according to the above-described structure of the present example, the permanent magnet 10a can be arranged in the position closer to the arc and the magnetic field of the permanent magnet 10a can act on the arc more efficiently than any of those of PTLs 1, 3, 4 and 5, whereby the current breaking performance can be enhanced more than the conventional structures. Thus, the permanent magnet 10a can he downsized more than the conventional ones.

Further, the fixed side insulating member 5a has low thermal conductivity, and can easily achieve sufficient performance as a heat insulating material for several tens of minutes which is a usual arc time, so that the permanent magnet 10a can he protected from the arc heat.

FIG. 3 illustrates the opening state of the switch gear, in which, since the permanent magnet 10a is arranged inside the fixed side insulating member 5a, an electric field on a surface of the fixed side insulating member 5a is weaken, and the permanent magnet 10a can be downsized, so that, due to a dielectric relieving effect according to a relative dielectric constant of the fixed side insulating member 5a, the electric field on the surface of the fixed side insulating member 5a is almost the same as that in the case where the permanent magnet 10a is not arranged. Thus, the current breaking performance can be enhanced and the disconnector can be downsized more than the conventional ones.

According to such a structure of the present example, the permanent magnet 10a can be arranged closely to the arc, so that the magnetic force can be converted into the arc driving force efficiently, and the permanent magnet 10a can be insulated from the arc heat by the fixed side insulating member 5a, whereby the magnetic deterioration can be suppressed, and the breaking performance can be secured over a long period of time.

In addition, also in the case where the disconnector is in the opening state of the switchgear, due to the dielectric relieving effect of the fixed side insulating member 5a, its body can be downsized, and the disconnector can also be downsized, so that a small-sized gas insulated switchgear can be provided.

### EXAMPLE 2

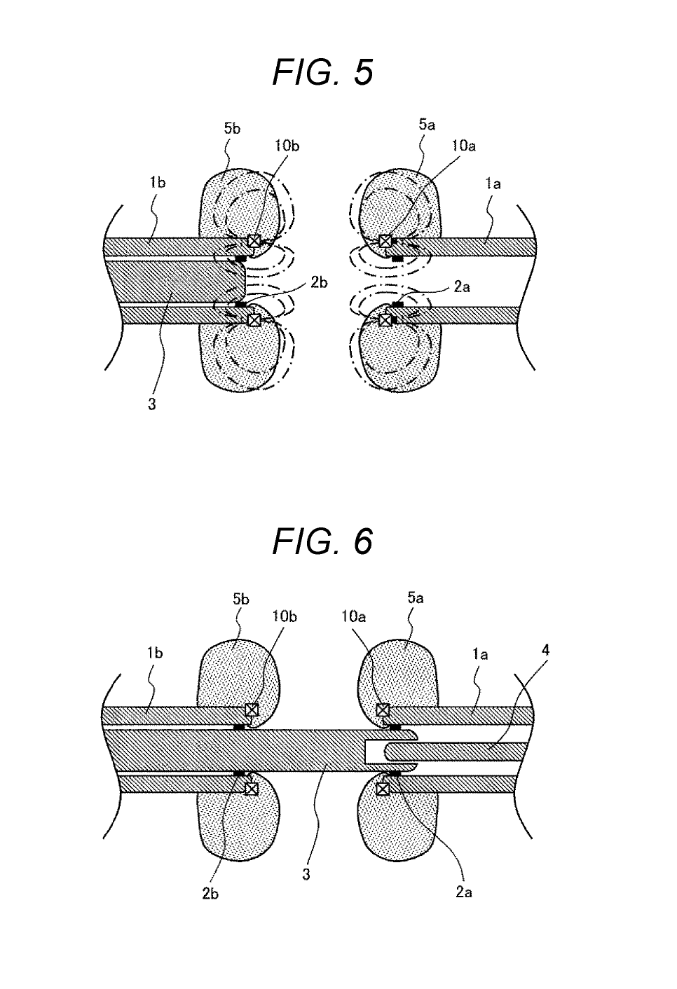

FIGS. 4 and 5 illustrate a gas insulation disconnector that is a switchgear in Example 2 of the present invention. FIG. 4 illustrates a state that the moving contact performs closing operation; and FIG. 5 illustrates a state that the moving contact performs opening operation.

In the present example shown in the figures, in addition to the structure of Example 1, a ring-shaped second permanent magnet 10b, being covered with the insulating member 5b, is provided on a tip portion of the movable side conductor 1b and closer to the fixed side conductor than to the movable side contactor 2b.

According to such a structure of the present example, in the case where the distance of the arc is long and the arc is not cut by the magnetic field of the permanent magnet 10a on the fixed side, the arc is cut by a magnetic field of the second permanent magnet 10b. Moreover, since an electric field at the tip of the movable side conductor 1b can be weaken by a movable side insulating member 5b more than that of Example 1 shown in FIGS. 1 to 3, an outer diameter of the movable side conductor 1b can be smaller than that of Example 1, by which a tank diameter thereof can be reduced more than that of Example 1.

FIG. 5 illustrates a state that the moving contact performs opening operation, in which the electromagnetic force applied to the ark can be increased more. In particular, in a state where the arc becomes sufficiently long in a latter half of the opening operation, the electromagnetic force can be applied efficiently to arc starting points on the fixed side and the movable side respectively, whereby the further downsizing of the permanent magnet 10a is possible. Moreover, since a distance between the fixed side conductor 1a and the movable side conductor 1b can be shortened by the fixed side insulating member 5a and the movable side insulating member 5b, the further downsizing compared with that of Example 1 is possible.

### EXAMPLE 3

FIG. 6 illustrates a gas insulation disconnector that is a switchgear in Example 3 of the present invention.

In the present example shown in the figure, in addition to the structure of Example 2 shown in FIGS. 4 and 5, an arc contact 4 is provided inside the fixed side conductor 1a, and a concave portion is formed in the tip of the moving contact 3, so that the arc contact 4 and the concave portion of the moving contact 3 may contact with and separate from each other.

In the present example as described above, since the arc is generated between the tip of the moving contact 3 and a tip of the arc contact 4 on the fixed side in the case of opening the moving contact 3, if an arc duration time is increased to about 100 minutes, current-carrying performance is less effected than those in the other examples, whereby the permanent magnet 10a on the fixed side and the second permanent magnet 10b on the movable side can be downsized. Further, damage of the fixed side contactor 2a can be suppressed, so that it is possible to elongate a period of inspecting the disconnector, and provide a more long-life gas insulated switchgear.

Accordingly, not only the effects that are similar to those of the above-described examples can be obtained, but also a merit of saving a life cycle cost can be added.

### EXAMPLE 4

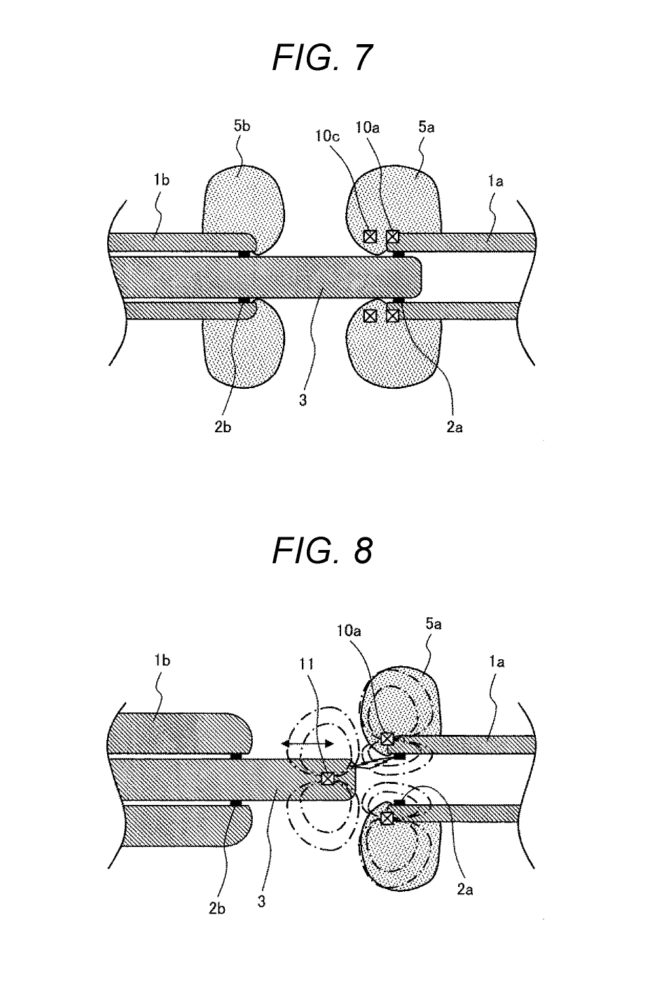

FIG. 7 illustrates a gas insulation disconnector that is a switchgear in Example 4 of the present invention

The present example shown in this figure is an example in which, in addition to the structure of Example 1, two layers of permanent magnets are provided on the fixed side.

That is, as shown in FIG. 7, a ring-shaped second permanent magnet 10c is provided adjacent to the ring-shaped permanent magnet 10a in the movable side conductor direction of this permanent magnet 10a, and the permanent magnet 10a and the second permanent magnet 10c are covered with the fixed side insulating member 5a, so that the second permanent magnet 10c is supported by the fixed side insulating member 5a.

According to such a structure of the present example, since the magnetic field that generates the arc driving force is a component in a direction of the tank diameter, by allowing the homopolar permanent magnet 10a and second permanent magnet 10c to face each other, the magnetic field in the direction of the tank diameter can be strengthened efficiently.

Thus, beside the effects that are similar to those of the above-described examples can be obtained, only a half of the magnetic field for breaking the arc is necessary due to the existence of the permanent magnet 10a and the second permanent magnet 10c, by which the permanent magnet 10a and the second permanent magnet 10c can be downsized.

Incidentally, in the above-described examples, the permanent magnets have ring shapes, but if many rectangular magnets are arranged in a ring, the similar effects can be exhibited.

### EXAMPLE 5

FIG. 8 illustrates a gas insulation disconnector that is a switchgear in Example 4 of the present invention.

The present example shown in this figure is an example in which, in addition to the structure of Example 1, a moving contact with permanent magnet 11 is arranged near the tip of the moving contact 3

That is, since, by arranging the moving contact with permanent magnet 11 near the tip of the moving contact 3 as in the present example, a temperature of the tip of the moving contact 3 becomes high due to the arc heat, if the moving contact with permanent magnet 11 is arranged near the tip of the moving contact 3 within a range that can suppress the magnetic deterioration, the magnetic field of the component in the direction of the tank diameter which acts on the arc can be strengthened as shown in FIG. 8, by which the permanent magnet 10a on the fixed side can be downsized.

Incidentally, the present invention is not limited to the above-described examples, and includes various modified examples. For example, the above examples are described in detail in order to explain the present invention for easy understanding, and the present invention is not necessarily limited to the structure that includes all, of the described components. Further, a part of a structure in one example can be replaced with a structure in another example, and a structure in one example can also be added to a structure in another example. Moreover, with respect to a part of a structure of each of the examples, another structure can be added, deleted and replaced.

### REFERENCE SIGNS LIST

1a fixed side conductor

1b movable side conductor

2a fixed side contactor

2b movable side contactor

3 moving contact

4 arc contact

5a fixed side insulating member

5b movable side insulating member

10a permanent magnet

10b, 10c second permanent magnet

11 moving contact with permanent magnet

1. A switchgear comprising:
a fixed side contactor that is provided to a fixed side conductor;
a moving contact that can be driven reciprocally with respect to the fixed side contactor, the moving contact being supported by a movable side conductor via a movable side contactor, the moving contact performing opening and closing operation by contacting to and separating from the fixed side contactor; and
a permanent magnet generating a magnetic field on an arc to extinguish the arc through the opening operation, the arc being generated between the fixed side contactor and the moving contact, wherein
the permanent magnet is provided on a tip portion of the fixed side conductor to be positioned closer to the movable side contactor side than the fixed side contactor, and the permanent magnet is covered with an insulating member.

2. The switchgear according to claim 1, wherein
the permanent magnet is provided on a periphery side of the tip portion of the fixed side conductor in the direction of the movable side conductor.

3. The switchgear according to claim 1, wherein
a second permanent magnet, being covered with an insulating member, is provided on a tip portion of the movable side conductor and closer to the fixed side conductor than to the movable side contactor.

4. The switchgear according to claim 3, wherein
an arc contact is provided inside the fixed side conductor, the arc contact contacting with and separating from the moving contact.

5. The switchgear according to claim 1, further comprising a second permanent magnet, being covered with and supported by an insulating member, is provided adjacent to the permanent magnet in the movable side conductor direction of the permanent magnet.

6. The switchgear according to claim 1, further comprising a permanent magnet being provided on the tip of the moving contact.

7. The switchgear according to claim 1, wherein
the permanent magnet and the second permanent magnet are formed in ring shapes.

8. The switchgear according to claim 1, wherein
at least one of the insulating members is curved on their facing side.

9. The switchgear according to claim 8, wherein the insulating member is made of epoxy resin.
